(19) United States
(12) Patent Application Publication
(10) Pub. No.: US 2007/0235573 A1
(43) Pub. Date: Oct. 11, 2007

(54) Apparatus for Materials Reduction

(76) Inventor: Raymond William Johnson, Queensland (AU)

Correspondence Address: YOUNG & THOMPSON, 745 SOUTH 23RD STREET, 2ND FLOOR, ARLINGTON, VA, 22202, US

(21) Appl. No.: 11/628,849

(22) PCT Filed: Jun. 8, 2005
(86) PCT No.: PCT/AU05/00821

§ 371 Date: Dec. 8, 2006

(30) Foreign Application Priority Data
Jun. 11, 2004 (AU) 2004903173

(51) Int. Cl. B02C 18/04

(52) U.S. Cl. 241/36; 241/83

(57) ABSTRACT

Apparatus for reducing materials for disposal having a frame for supporting a material reduction station, a holding station and a disposal station. The reduction station has a first and second reduction zone and a hopper with a first passage arranged to convey materials reduced or shredded by cutting elements to second cutting elements, and a second passage arranged to convey materials directly to the second cutting elements. The second passage has a retardation arrangement for retarding materials downstream from flowing past and out through the second passage. A perforated screen cooperates with the second cutting elements to reduce the materials to a size determined by the size of the perforations. The holding station includes a tray having a holding space for temporarily holding reduced materials from the second reduction zone, and an outlet port in communication with a container in the disposal station.

### TECHNICAL FIELD OF THE INVENTION

THIS INVENTION relates generally to an apparatus for material reduction, and in particular but not limited thereto, the apparatus having material reduction means for reducing materials into a predetermined particle size, suction means for guiding the reduced materials into a container for disposal.

### BACKGROUND OF THE INVENTION

People working in business and government organisations use paper materials for taking notes, writing, or drafting and printing reports and correspondence. The usage of paper materials in these organisations continue to grow significantly despite the advent of the personal computers intended to facilitate “paperless” offices. People in these organisations also generally use a large volume of other materials such as packaging containers, paper and plastic containers for food items, and plastic bottles and metal cans for beverages. Following consumption, the above materials are normally stored in bins to be emptied regularly.

In organisations having sensitive information, the paper containing sensitive information are normally shredded before being disposed. The shredded materials are manually disposed into bins for disposal. It is noted that the volume of these materials increases considerably when shredded. Shredding therefore increases the frequency required for emptying bins. The costs for disposing the above materials are accordingly high.

The shredded materials can be sorted and put together in a reasonably short time to reveal the information contained in the documents before being shredded. The prior art shredding machines therefore do not meet the requirements of such organisations including the military, government departments and businesses, that need to totally destroy documents with secret or highly secretive information to ensure the information can not be revealed.

Sensitive information can also be stored on recordable media such as floppy disks, hard disks, compact discs (CDs), digital video discs (DVDs), etc. The computer files on these media can be accessed even if they are deleted.

Accordingly there is a need to reduced these media into small fragments to safeguard the sensitive information.

### OBJECT OF THE PRESENT INVENTION

An object of the present invention is to alleviate or to reduce to a certain level one or more of the above prior art disadvantages.

### Outline of the Present Invention

In one aspect therefore the present invention resides in an apparatus for materials reduction. The apparatus includes a material reduction station having at least one reduction zone with reducing means arranged therein for reducing materials fed thereto, a transfer station arranged to receive the reduced materials from the reduction station, and a disposal station in communication with the transfer station. The transfer station has a holding space configured to receive the reduced materials from the reduction station and an outlet port through which the reduced materials are conveyed to the disposal station. Arranged in the holding space of the transfer station is agitation means configured to agitate the reduced materials in the holding space. The agitation means has one or more flexible filaments fixed to a rotatable spindle. Whereby, when the spindle is rotating, the one or more flexible filaments cause the reduced materials to move. The apparatus further includes suctions means arranged to draw the reduced materials in the space through the outlet port and into the disposal station.

In preference; the apparatus includes a guide hopper arranged to guide the materials for reduction to flow to one or more of the at least one reduction zone.

It is preferred that the apparatus includes two or more reduction zones and one of reduction zones is arranged upstream of the guide hopper. The reducing means in said one reduction zone is configured to reduce the materials fed into the said one reduction zone to first predetermined size, and the reducing means in the other(s) of said two or more reduction zones is arranged to reduce the materials fed therein into a size smaller than said predetermined size. The materials reduced to said first predetermined size in said one reduction zone are guided by the guide hopper to flow into the other(s) of said two or more reduction zones.

Advantageously, the reducing means in said one reduction zone is of a cross cut type arranged to cut along two crossing directions.

The reducing means in the other(s) of said two or more reduction zones may have a rotatable cutter positioned adjacent to a screen with through perforations of a predetermined configuration. The screen is positioned upstream of the holding station, whereby only materials reduced to a configuration smaller than the perforations can flow past the screen into the holding station.

Preferably, the screen is removably fixed in the reduction station so that a user can selectively replace the screen with a screen of suitable through perforations.

The guide hopper may have a primary flow passage arranged to guide materials for reducing through the other(s) of said two or more reduction zones, and a secondary flow passage arranged to guide materials for reducing through the or one of the other(s) of said two or more reduction zones, and thereby by-passing the primary flow passage. Whereby, materials for reduction can be selectively fed through the primary or secondary flow passage.

Advantageously, an outflow retardation means is arranged in the secondary flow passage to retard the materials downstream from the retardation means to flow out through the secondary flow passage. The retardation means may be in the form of a flap configured to be normally in a closed position whereat the flap retards flow of the materials downstream thereof, and to be caused to move to an open position by materials inserted into the secondary flow passage. The retardation means may also be in the form of vanes or bristle arranged on a rotatable shaft extending across the secondary flow passage. The vanes or bristle are configured to retard outflow of the materials downstream thereof and to facilitate materials upstream thereof to move past them.

The one or more flexible filaments are preferably nylon lines such as those used in a brush cutter. The flexible filaments being arranged normally in a curl and able to stretch when rotating and change position when contacting any wall surface around the space, will substantially cause most reduced materials in the space to move. Thereby, the agitation means facilitates substantially all of the reduced materials in the space to be drawn through the outlet port, and thereby substantially minimises clogging due to accumulation of the reduced materials.

The disposal station preferably has a container in communication with the outlet port. The suction means is arranged to draw the reduced materials through the outlet port and into the container.

It is preferred that the apparatus includes switch means arranged in cooperation with the container so that when weight of the reduced materials in the container is at or above a preset value, the switch means switches to cause the apparatus to provide an indication signal and/or to cut off power supply to the suction means and/or reducing means.

In one form, the container is supported on a movable base that is biassed to be remote from the switch means, and the base is arranged to move progressively in a direction towards the limit switch in accordance to the weight of the reduced materials in the container. When the weight is at or above said preset value, the container is in a position to cause the switch means to cause the apparatus to provide the indication signal and/or to cut off power supply to the cutting means.

The switch means may be a limit switch or a proximity switch.

Preferably, a hydraulic ram or spring is arranged to bias the base to a position remote from the switch means. The bias on the base is progressively overcome with weight of the reduced materials in the container.

The container may have a disposal bag therein and the reduced materials are drawn from the outlet port into the bag. The container may also have a body with an interior chamber and an open top, and a lid removably secured to close the open top. The disposal bag is positionable through the open top into the chamber.

The suction means may be positioned within the chamber in a position below the disposal bag when positioned in the chamber so that the suction means provides a substantial vacuum source for drawing the reduced materials through the outlet port into the bag.

The suction means also compacts the reduced materials in the container so that the apparatus is able to store more reduced materials per volume of the container. When the lid is secured on the body, the container is virtually air tight so that little reduced materials can escape from the container or bag before disposal.

The applicant has surprisingly found that cutting materials in two or more cutting zones actually speeds up the time necessary to reduce most materials to a desired size, in comparison to a single cutting zone where the materials are cut by single cutting means.

The apparatus may include a frame configured to support the reduction station, the transfer station and the disposal station therein, and modular panel members are arranged to removably fixed to the frame. The modular panels may incorporate sound proofing materials to minimise noise.

The through apertures in the screen are configured so that the materials in the corresponding reduction zone are reduced to particles at or under a predetermined size.

The apparatus may have a duct member interconnecting the outlet port of the holding station and the container, and suction means being arranged to draw the reduced materials in the space of the holding station to flow through the outlet port and along the duct member into the container.

### BRIEF DESCRIPTION OF THE DRAWINGS

In order that the present invention can be more readily understood and be put into practical effect reference will now be made to the accompanying drawings which illustrate non-limiting embodiments of the present invention and wherein:

FIG. 1 is an exploded perspective view of an embodiment of the apparatus according to the present invention;

FIG. 2 shows in detail the hopper for the apparatus shown in FIG. 1;

FIG. 3 shows in detail the holding station for the apparatus shown in FIG. 1;

FIG. 4 shows the apparatus of FIG. 1 with the components partly in positioned in the frame;

FIG. 5 is a plan sectional view the apparatus with all components positioned within the frame;

FIG. 6 is a side sectional view the apparatus shown in FIG. 5; and

FIG. 7 is a perspective view of another embodiment the apparatus according to the present invention.

### DETAILED DESCRIPTION OF THE INVENTION

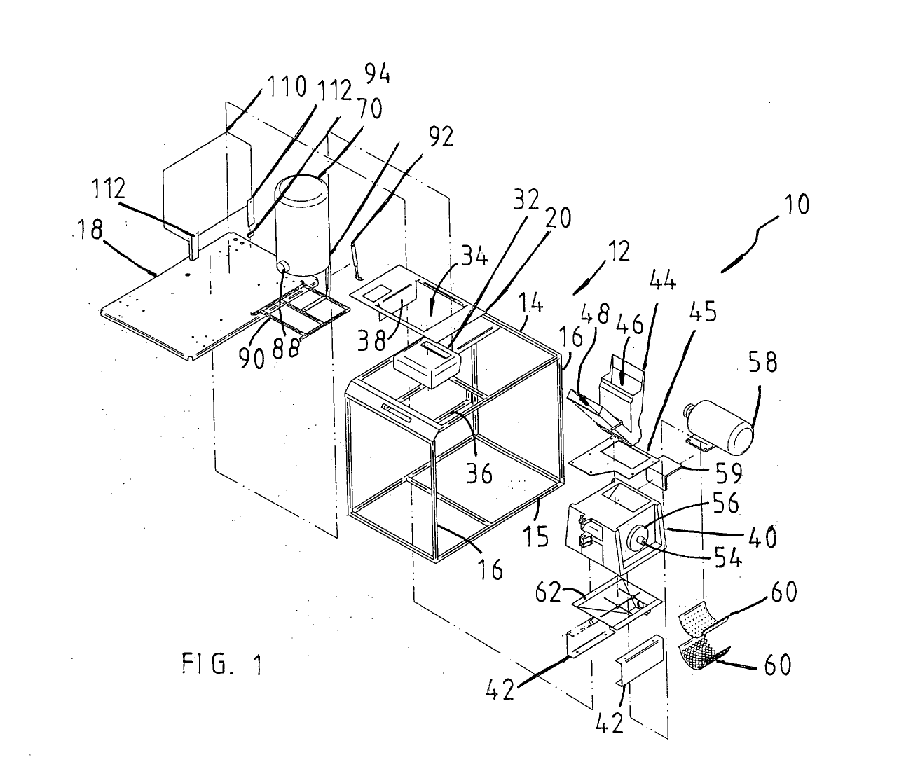

Referring initially to FIG. 1 there is shown an embodiment of the apparatus 10 according to the present invention. The apparatus 10 as shown has a frame 12 formed of a top and bottom sets of connected horizontal elongate members 14 and 15, and vertical elongate members 16 interconnecting said top and bottom sets. A support panel 18 is fixed to the bottom horizontal elongate members 15 of the frame 12, and a cover panel 20 is fixed to the top horizontal elongate members 14.

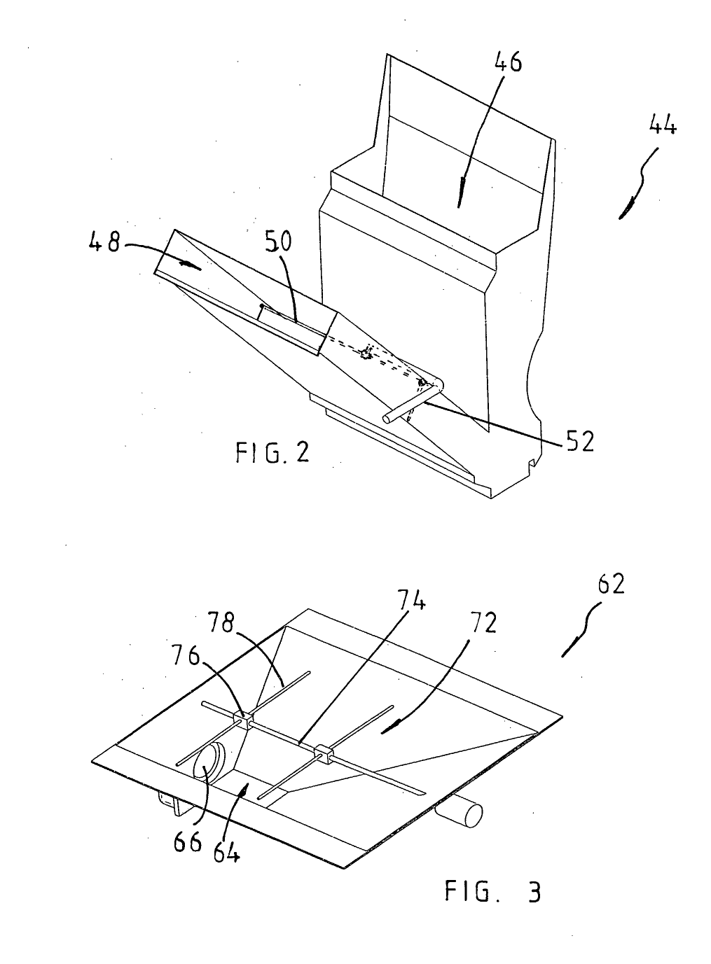

As shown more clearly in FIG. 6, the apparatus 10 has a materials reduction station 22, a holding station 24 and a disposal station 26. The reduction station 22 includes a first reduction zone 28 and a second reduction zone 30. First cutting means 32 in the form of a cross-cut shredder is positioned in a recess 34 of the cover panel 20. A U-shaped support element 36 fixed to two adjacent elongate members 14 and down turned flanges 38 of the cover panel 20 are arranged to maintain the shredder 32 in position. The second reduction zone 30 includes second cutting means 40 supported on two spaced channel elements 42 fixed to the support panel 18. Positioned between the reduction zones 28 and 30, is hopper 44 (see FIG. 2) with a first passage 46 arranged to convey materials reduced. or shredded by the first cutting means 32 to the second cutting means 40, and a second passage 48 arranged to convey materials for reduction directly to the second cutting means 40. The second passage 48 has a retardation arrangement for retarding materials downstream from flowing past and out through the second passage 48. In this embodiment, the retardation means has a pivotally movable flap 50 arranged to normally close the passage 48. The flap 50 tilts inwardly when materials for reduction inserted into the passage 48 come into contact with the flap 50, whereby the passage 48 is opened to allow the materials to flow to the second reduction zone 30. The retardation arrangement has a lever 52 for manually turning the flap 50 to open the passage 48. Due to gravity, the flap 50 automatically returns to its normal position to close the passage 48. An alternative retardation arrangement (not shown) may be in the form of a rotating rod extending across the passage 48 and the rod has flexible plates or bristle extending outwardly therefrom and configured to guide materials inserted into the passage 48 to flow therepast, but retarding flow of materials out of the passage 48.

In this embodiment the first cutting means 32 has an inbuilt motor to rotate the cutting elements (not shown). The second cutting means 40 has cutting elements (not shown) fixed to a shaft 54. The shaft 54 is connected to a pulley 56 which is linked to a flywheel (not shown). A motor 58 is arranged to drive the flywheel and thereby turning the cutting elements of the second cutting means. The motor 58 is positioned on a support bracket 59 that is fixed to the second cutting means 40. A perforated screen 60 is arranged to cooperate with the cutting elements of the second cutting means to reduce the materials to a size that is determined by the size of the perforations. FIG. 1 shows two screens 60, the one with smaller perforations being for reducing materials to finer particles. The smaller perforation screen is replaced with the larger perforation screen where coarser particles are desired. As can be seen, the hopper 44 is fitted to an alignment panel 45 that is secured to the second cutting means 40.

The holding station 24 includes a tray 62 configured with a holding space 64 for temporarily holding reduced materials from the second reduction zone 30, and an outlet port 66 in communication with a container 70 in the disposal station 26. Arranged in the space 64 is an agitation arrangement 72 for agitating the reduced materials to flow or move so that substantially no reduced materials remain on the walls of the tray 62. The agitation arrangement has rod 74 extending in the space 64. The rod 74 carries two blocks 76 with flexible nylon lines 78 extending therefrom. The nylon lines 78 are normally curled and will extend when the rod 74 rotates. The nylon lines 78 also change direction when contacting the wall of the tray 62. In this manner, the lines 78 will cause reduced materials on any parts of the walls to move. The rod is driven by the motor 58 through drive links (not shown).

A tube (not shown) connects the outlet port 66 to the inlet port 80 of the container 70. A suction or vacuum source (not shown) in the container 70 is arranged to draw the reduced materials in the space 64 to flow through the outlet port 66, along the tube and through the inlet port 88, into the container 70. The container 70 has a disposal bag (not shown) similar to that in a vacuum cleaner to collect the reduced materials.

The apparatus 10 has an indication arrangement for indicating when the disposal bag requires emptying. In this embodiment, the container 70 is placed on a floating platform 90 which is supported on a gas strut 92. The platform 90 is normally positioned above a limit switch 94. The gas strut 92 retreats progressively as the weight of the reduced materials in the container 70 increases. The gas strut 92 is arranged so that when the reduced materials in the container reaches a predetermined weight the platform 90 will contact the switch 94 to cause the switch 94 to initiate an alert arrangement (not shown) to indicate a signal for emptying the disposal bag. In this embodiment, the power supply to the motor 58 and the shredder 32 is also caused to be cut off when the switch 94 switches.

Electrical control devices (not shown) are placed in an electrical cabinet 110. Brackets 112 fixed to the support panel 18 are arranged to support the cabinet 110 on the base 18.

Referring to FIG. 4, the apparatus 10 has four cover panels 96 for covering the sides of the frame 12. The panels 96 and the frame 12 are configured so that the panels 96 can be easily removed. In addition to the top cover 20, another top cover 21 is provided to cover the disposal station 26. A protective cladding 98 with angled channel sections are arranged to cover the top edges of the panels 96. The front section 99 of the cladding 98 has an opening 100 through which materials for reduction can be inserted into the passage 48. The cover 21 is sized so that it can be lifted off for disposal of the bag in the container 70. A hood 102 is configured to fit over the shredder 32.

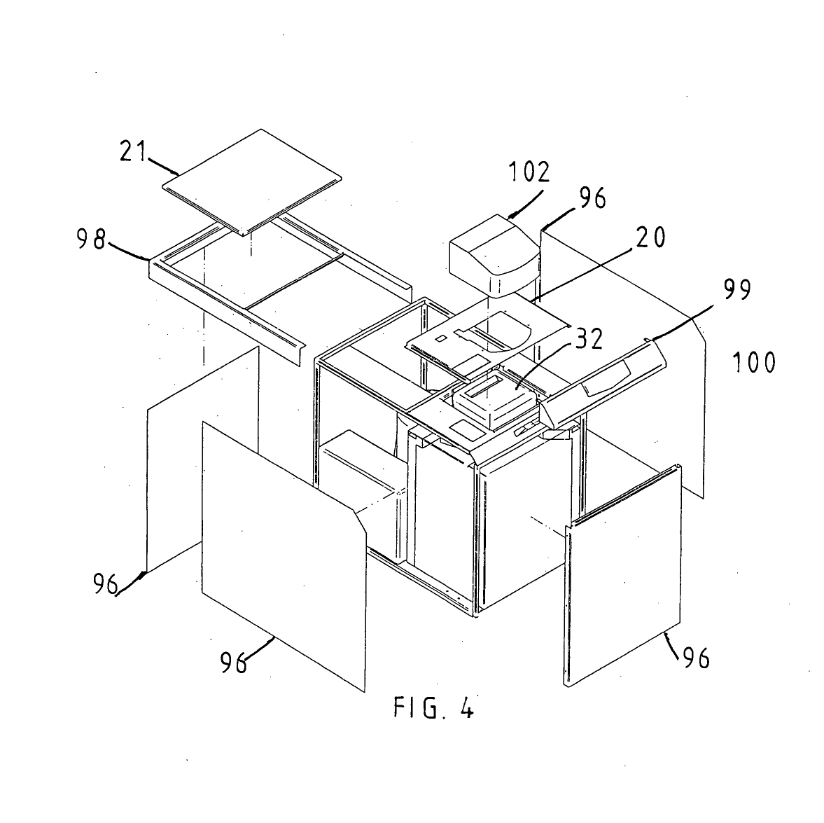

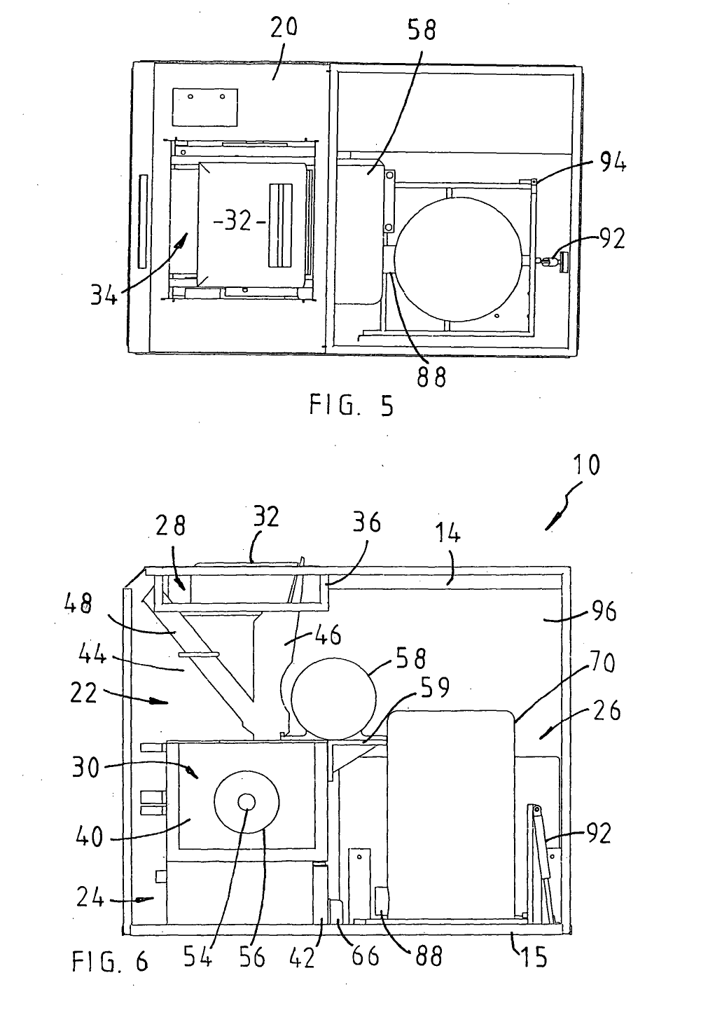

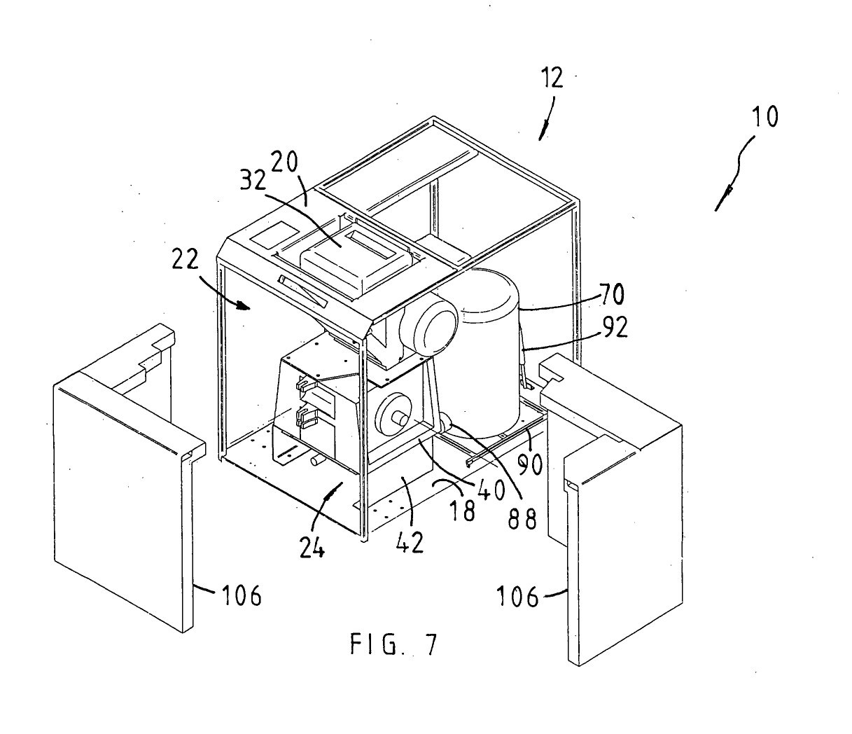

The apparatus 10 shown in FIG. 7 is substantially the same as that shown in FIGS. 1 to 6, except for two sound proofing covers 106 arranged around the reduction station 22 and the holding station 24.

Whilst the above has been given by way of illustrative examples of the present invention, many variations and modifications thereto will be apparent to those skilled in the art without departing from the broad ambit and scope of the invention as herein set forth in the following claims.

1. An apparatus for materials reduction including a material reduction station having at least one reduction zone with reducing means arranged therein for reducing materials fed thereto, a transfer station arranged to receive the reduced materials from the reduction station, and a disposal station arranged in communication with the transfer station; the transfer station having a holding space configured to receive the reduced materials from the reduction station, an outlet port through which the reduced materials are conveyed to the disposal station, and agitation means arranged in the holding space and configured to agitate the reduced materials in the holding space, the agitation means having one or more flexible filaments fixed to a rotatable spindle, whereby, when the spindle is rotating, the one or more flexible filaments cause the reduced materials in the holding space to move; and further including suction means arranged to draw the reduced materials in the holding space through the outlet port and into the disposal station.

2. The apparatus according to claim 1 further including a guide hopper arranged to guide materials for reduction inserted therein to flow to one or more of the at least one reduction zone.

3. The apparatus according to claim 2 wherein material reduction station having two or more reduction zones and one of reduction zones is arranged upstream of the guide hopper, the reducing means in said one reduction zone being configured to reduce the materials fed into the said one reduction zone to a first predetermined size, and the reducing means in the other(s) of said two or more reduction zones being arranged to reduce the materials fed therein into a size smaller than said first predetermined size, and the materials reduced to said first predetermined size in said one reduction zone are guided by the guide hopper to flow into the other(s) of said two or more reduction zones.

4. The apparatus according to claim 3 wherein the reducing means in said one reduction zone is of a cross cut type arranged to cut along two directions that cross each other.

5. The apparatus according to claim 3 wherein said reducing means in the other(s) of said two or more reduction zones having a rotatable cutter positioned adjacent to a screen with through perforations of a predetermined configuration, the screen being positioned upstream of the holding station, whereby only materials reduced to a configuration smaller than the perforations can flow past the screen and into the holding station.

6. The apparatus according to claim 6 wherein the screen is removably fixed in the reduction station so that a user can selectively replace the screen with a screen of suitably configured through perforations.

7. The apparatus according to claim 5 wherein the through apertures in the screen are configured so that the materials in the corresponding reduction zone are reduced to particles at or under a predetermined size.

8. The apparatus according to claim 3 wherein the guide hopper having a primary flow passage arranged to guide materials for reduction through the other(s) of said two or more reduction zones, and a secondary flow passage arranged to guide materials for reduction through said one of said two or more reduction zones, thereby by-passing the primary flow passage.

9. The apparatus according to claim 8 wherein outflow retardation means being arranged in the secondary flow passage to retard the materials downstream from the retardation means to flow out through the secondary flow passage.

10. The apparatus according to claim 9 wherein said retardation means is in the form of a flap configured to be normally in a closed position, whereat the flap retards outflow of the materials downstream thereof, and to be caused to move to an open position by materials inserted into the secondary flow passage.

11. The apparatus according to claim 9 wherein said retardation means being in the form of vanes or bristle arranged on a rotatable shaft extending across the secondary flow passage, the vanes or bristle being configured to retard outflow of the materials downstream thereof and to facilitate materials upstream thereof to move past them.

12. The apparatus according to claim 1 wherein each of the one or more flexible filaments being arranged normally in a curl and being able to stretch out when the spindle is rotating and change position when contacting any wall surface around the holding space, whereby said one or more flexible filaments rotating with the spindle substantially cause the reduced materials in the space to move and be drawn through the outlet port.

13. The apparatus according to claim 1 wherein said one or more flexible filaments are each formed of a nylon line.

14. The apparatus according to claim 1 wherein the disposal station having a container in communication with the outlet port, and the suction means is arranged to draw the reduced materials through the outlet port and into the container or a disposal bag positioned therein.

15. The apparatus according to claim 14 wherein an indication arrangement is provided for indicating when the container or the disposal bag therein requires emptying.

16. The apparatus according to claim 15 wherein the indication arrangement having switch means arranged in cooperation with the container so that when weight of the reduced materials in the container or the disposal bag is at or above a preset value the switch means switches to cause the indication arrangement to provide an indication signal and/or to cut off power supply to the suction means and/or reducing means.

17. The apparatus according to claim 16 wherein the container is supported on a movable base that is biassed to be remote from the switch means, and the base is arranged to move progressively in a direction towards the switch means in accordance to increasing weight of the reduced materials in the container or the disposal bag, the switch means being positioned so that when the weight is at or above said preset value, the container is in a position to cause the switch means to cause the indication arrangement to provide the indication signal and/or to cut off power supply to the suction means and/or reducing means.

18. The apparatus according to claim 17 wherein a hydraulic ram or spring is arranged to bias the base to an initial position remote from the switch means, and the bias on the base is progressively overcome with the increasing weight of the reduced materials in the container or the disposal bag.

19. The apparatus according to claim 16 wherein said switch means is a limit switch or a proximity switch.

20. The apparatus according to claim 19 wherein the container having a body with an interior chamber, an open top, and a lid removably secured to close the open top, the disposal bag is positionable through the open top into the chamber.

21. The apparatus according to claim 20 wherein said suction means is positioned within the chamber in a position below the disposal bag positioned in the chamber so that the suction means provides a substantial vacuum source for drawing the reduced materials through the outlet port into the bag.

22. The apparatus according to claim 1 wherein the suction means is arranged to compact the reduced materials in the container so that the container is able to store more reduced materials per volume.

23. The apparatus according to claim 1 further including a frame configured to support the reduction station, the transfer station and the disposal station therein, and modular panel members are arranged to removably fixed to the frame.

24. The apparatus according to claim 23 wherein said modular panels incorporate sound proofing materials to minimise noise.

25. The apparatus according to claim 14 wherein a duct member is arranged to interconnect the outlet port of the holding station and the container, and suction means is arranged to draw the reduced materials in the holding space of the holding station to flow through the outlet port and along the duct member into the container.
